(19) United States
(12) Patent Application Publication
(10) Pub. No.: US 2014/0279337 A1
(43) Pub. Date: Sep. 18, 2014

(54) SYSTEMS AND METHODS FOR BUNDLING DIAMONDS INTO VALUED GROUPINGS

(71) Applicant: Martin Rapaport, Jerusalem (IL)

(72) Inventor: Martin Rapaport, Jerusalem (IL)

(73) Assignee: The Rapaport 2012 Family Trust, Las Vegas, NV (US)

(21) Appl. No.: 13/794,850

(22) Filed: Mar. 12, 2013

(51) Int. Cl. G06Q 40/04

(52) U.S. Cl. CPC G06Q 40/04
USPC 705/37

(57) ABSTRACT

This disclosure relates to systems for bundling diamonds and determining a relative value of the diamonds within the bundle and the value of the bundle. Also described are methods for using the determined relative diamond values in diamond transactions and contracts.

### FIELD

This disclosure relates to systems and methods for bundling diamonds and pricing bundles of diamonds by determining a relative value of the diamonds within the bundle. Also described are methods for using the determined relative diamond values in diamond transactions and contracts.

### BACKGROUND

The ability to commoditize and trade a natural resource greatly relies on the uniformity and interchangeability of single units within a grouping of the particular resource. For this reason, diamonds, a natural resource having myriad variations of shape, size, color, clarity, cut, polish, symmetry, fluorescence, and cut potential (for uncut stones) have historically been resistant to commoditization, and have been unavailable for forms of trading and investment common to classic commodities, such as soybeans and natural gas. In contrast to commodities which are traded in interchangeable units, contracts governing diamond trading are typically linked to particular physical specifications for the types of diamonds being traded. Such linkage greatly limits the ability to substitute diamond types at the time of contract performance and stone delivery, and subjects performance of diamond contracts to possible shortages of stones of a specified physical characteristic.

Thus, a need remains for a system that will enable commoditization of diamonds in order to facilitate diamond trading and investment.

### SUMMARY

Described herein is a computer-implemented method for bundling diamonds into valued groupings, by which relative values or “points” are assigned to each diamond type in the bundle. Assigned diamond points can then be used as units of exchange in points-based contracts, which are also described. One of skill will appreciate that the described method can be adapted to assign points to bundles of gemstones other than diamonds, such as, but not limited to, rubies, emeralds, and sapphires. The described method can also be adapted to bundle and assign points to precious metals such as, but not limited to, gold, silver, and platinum.

The described method is carried out by first accessing market data for available diamond types in the universe of diamonds, wherein the market data includes at least one market price for each diamond type. Market prices for diamond types in a diamond bundle are then selected and obtained, from the market data. The method includes analyzing the obtained market prices for each diamond type in the bundle; assigning a market price to each diamond type in the bundle based on the analyzed market prices; determining a reference diamond type from the universe of diamonds; assigning a market price for the reference diamond; assigning a number of points to each diamond type in the bundle based on their market price, relative to that of the reference diamond; storing in a memory, the diamond types in the diamond bundle and the point values for each diamond type; and displaying on a display the point value for each diamond type in the diamond bundle.

Also described herein are computer systems for implementing the described methods. The described systems include a processor, memory, display, and means for sending and receiving data.

The foregoing and other objects, features, and advantages will become more apparent from the following detailed description, which proceeds with reference to the accompanying figures.

### BRIEF DESCRIPTION OF THE DRAWINGS

FIG. 1 shows an exemplary system for carrying out the computer implemented method described herein.

FIG. 2 is a process flow-chart, showing an example of the described computer-implemented method of determining relative value of diamonds in a selected diamond bundle.

FIG. 3 is a sub-process flow-chart, showing an example of the sub-process of evaluating market prices, as indicated in FIG. 2.

FIG. 4 is a process flow-chart, showing an example of updating the relative value (points) of diamonds in a bundle, in view of changed market values.

FIGS. 5A and 5B show two examples of sub-bundling a diamond bundle. “Sub-bundles” are indicated by numbered ovals.

### DETAILED DESCRIPTION

### I. Terms

Unless otherwise explained, all technical and financial terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

In case of conflict between the present specification and the commonly-understood meaning of terms used herein, the present specification, including explanations of terms, will control. In addition, all the materials, methods, and examples are illustrative and not intended to be limiting.

Average: The mean, mode, and/or median of a group of values. As used herein, the “average market price” of a diamond type can encompass the mean, mode, or median of a collection of market prices, depending on the method used to determine the average market price.

Diamond Bundle: A grouping of diamond types, selected from the universe of diamond types. Grouping criteria are based on at least one diamond physical characteristic including, but not limited to, shape, size, cut, clarity, color, polish, symmetry, fluorescence, finish, light performance and, in particular examples the grading laboratory used to grade the above characteristics. In particular examples, the grouping criteria are selected by a user. In other examples, the grouping criteria are a pre-selected aspect of the systems and computer-implemented methods described herein. In particular examples, the diamond types in a diamond bundle correspond to actual diamonds gathered together for sale as a group. In other examples, the diamond types in a diamond bundle correspond to a gathering of data related to diamonds matching the designated grouping criterion.

Diamond Points: A relative measure of value determined for each diamond type in a diamond bundle, in relation to the average market price or price per carat of a reference diamond.

Market Data: Data encompassing diamond transactions. Market data includes diamond asking prices, bids on diamonds offered for sale and transaction (e.g. cash transaction) prices, and include the price per carat for particular diamond types. In particular embodiments, market data includes diamond type availability, diamond production forecasts, terms of sale for diamond transactions and the like. Market data can include at least one market price for each diamond type in a diamond bundle.

Reference Diamond: A diamond type used to determine the relative diamond points for each diamond type in a diamond bundle. A reference diamond can be any diamond type from the universe of diamonds. In particular examples, a reference diamond is one of the diamond types in a diamond bundle, such as a diamond type of approximately average value (relative to the other diamonds in the bundle), regardless of whether the value is a function of market price or of one or more grouping criteria of the bundle (color, clarity, etc.). In other embodiments, the reference diamond is a diamond of median quality (as understood in the art) among the diamonds in a diamond bundle. In particular examples, the reference diamond is determined as part of the process of determining relative diamond points for a bundle of diamond types. In other examples the reference diamond is determined apart from the process of determining relative diamond points for the diamond types in a diamond bundle. In still other examples, a “referenced diamond” is not a particular diamond type, but rather a calculated value, such as the average value of particular diamond types.

Universe of Diamonds: All of the diamonds in the world for which market data is available. The universe of diamonds can include diamonds of all possible combination of diamond characteristics including, but not limited to, size ranges, shape, cut, clarity, color, polish, symmetry, and fluorescence. A “diamond type” is a particular combination of diamond characteristics, for example a one-carat, round stone of E color and VVS1 clarity. In particular examples, a characteristic of a diamond type also includes the gemological laboratory used to determine the diamond's physical characteristics.

### II. Brief Description of Several Embodiments

Described herein is a computer-implemented method for bundling diamonds into valued groupings. The method is carried out by first accessing market data for available diamond types in the universe of diamonds, wherein the market data includes at least one market price for each diamond type. Market prices for diamond types in a diamond bundle are then selected and obtained from the market data. The method includes analyzing the obtained market prices for each diamond type in the bundle; assigning a market price to each diamond type in the bundle based on the analyzed market prices; determining a reference diamond type from the universe of diamonds; assigning a market price for the reference diamond; assigning a relative number of points to each diamond type in the bundle based on their market price, relative to that of the reference diamond; storing in a memory, the diamond types in the diamond bundle and the relative point values for each diamond type; and displaying on a display the point value for each diamond type in the diamond bundle.

In particular embodiments of the described method, the user selects all characteristics of the diamond types in the diamond bundle. In other embodiments, all characteristics of the diamond types in the diamond bundle are pre-selected. In still other embodiments, some characteristics of the diamond bundle are pre-selected, and other characteristics of the diamond bundle are user-selected. In further embodiments, the user selects the diamond types in the diamond bundle according to one or more characteristic selected from the group consisting of: diamond number, weight, cut, shape, color, clarity, and symmetry.

In particular embodiments, the market data is accessed and obtained from a single source of market data. In other embodiments, the market data is accessed and obtained from multiple sources of market data. In still other embodiments, the market data is simultaneously accessed and obtained from multiple sources of market data.

In particular embodiments, analyzing the obtained market prices includes determining the average market price of each diamond within the diamond bundle. In other embodiments, evaluating the obtained market prices include a statistical analysis of the obtained prices, which in particular examples, can be used to remove outliers from the obtained prices.

In particular embodiments, the diamond bundle is virtually arranged according to the assigned market price. In other embodiments, the diamond bundle is arranged according to differences in at least one physical characteristic comprising size ranges, shape, cut, clarity, color, polish, symmetry, and fluorescence.

In particular embodiments, the reference diamond is among the diamond types in the diamond bundle. In other embodiments, the reference diamond is not among the diamond types in the diamond bundle.

In some embodiments, determining a market price for the reference diamond includes accessing market data for the reference diamond; obtaining market data for the reference diamond; and based on the obtained market data, assigning a market price (e.g. an average market price) to the reference diamond.

In still other embodiments, the method further includes communicating the determined relative point value for each diamond type in the diamond bundle to an external computer, including a database of diamond bundles and points.

In particular embodiments, the method includes updating the determined point values for each diamond type in the diamond bundle to account for changes in market prices of the diamonds in the bundle; storing in the memory the updated point values; and displaying on the display the updated point values. In some examples, the method includes updating the point values each time the diamond bundle and corresponding point values are accessed from the memory, such as by a user creating a new points-based

[symbol]

In particular embodiments, the method further includes accessing from the memory, the diamond bundle and corresponding point values for use in a diamond-points based contract, such as a sales contract or a futures contract.

Systems for executing the described methods, which include a processor, memory, display, and means for sending and receiving data are also described.

One of skill will appreciate that the described method can be adapted to assign points to bundles of gemstones other than diamonds, such as, but not limited to, rubies, emeralds, and sapphires. The described method can also be adapted to bundle and assign points to precious metals such as, but not limited to, gold, silver, and platinum.

### III. A System and Method for Bundling Diamond into Valued Groupings

Described herein is a system and computer-implemented method for defining the relative value of diamond types within a sub-group or “bundle” of diamonds selected from the universe of diamonds. The defined relative values are expressed as interchangeable diamond “points” having equal monetary value. The assignment of points to diamonds within a bundle enables creation of diamond trading contracts disconnected from the variability in diamond stone characteristics that has defined diamond trading to-date.

### System Components

An exemplary configuration of the described system is shown in FIG. 1. The described system requires a computer processor (10), means for sending and receiving data (15) to external databases (e.g. by the internet), memory (20), and a display (30). The method implemented by the system requires that the processor (10) has access to the cloud of market data (40) for the universe of diamonds. The market data can be from a single source (e.g. 40a) or from multiple sources (e.g. 40a, b, and c). Also included in the exemplary system is a random number generator (45), which can be used in implementing a diamond-points based contract.

One of skill in the art will appreciate that myriad computer types are suitable for use in the system shown in Example 1 and for carrying out the described method. However, the processor (10) and memory (20) must be sufficiently robust to access, compile, and optionally store temporally-variable market data related to the universe of diamond types. Moreover, the processor (10) must be able to access such market data from multiple sources simultaneously, or nearly simultaneously.

The processor (10) accesses the cloud of market data (40) by means for sending and receiving data (15), for example, by way of standard computer hardware for connecting to internal (e.g. intranet) or external (e.g. internet) computer networks. In particular embodiments, the computer (10) is continually connected to the network (with allowance for connectivity disruptions) to continually update the market data. In other embodiments, the computer (10) updates market data stored in memory (20) on a pre-determined periodic basis.

In particular embodiments, aspects of the computer-executed methods described herein require user input. One of skill in the art will appreciate that numerous user interfaces (50) are encompassed within the described system, including but not limited to, keyboard, mouse, touch screen, and voice recognition interfaces. Similarly, the described display (30) can be any computer display, including a touch screen display, where applicable.

Overview of a Method for Bundling Diamonds into Valued Groupings

FIG. 2 provides an overview of an exemplary embodiment of the described method. With reference to FIG. 2, the method begins with the computer accessing market data for the universe of diamonds (110). The computer next selects and obtains market prices (from the cloud of market data) for each diamond type in the bundle (120). The market prices for each diamond type are analyzed and a price, such as an average price (e.g. mean, median, or mode) is assigned for each diamond type in the diamond bundle (130, and FIG. 3). Next, a reference diamond is determined from the universe of diamonds types (140), and a price, such as the average price (e.g. mean, median, or mode) of the reference diamond is determined (150). Next, relative diamond points are assigned to each diamond type in the bundle, relative to the value of the reference diamond (160). The diamonds types in the bundle and the assigned diamond points are stored in the memory (170), and also displayed on the display for access by a user (180).

The below sections describe the steps of the disclosed method in detail.

### Bundling of Diamond Types

The systems and methods described herein relate to bundles of diamonds selected from the universe of diamonds, inclusive of cut and rough diamonds. Diamond bundles contain at least 1 diamond type, but do not have a maximum possible number of diamond types. One of skill will appreciate that the described methods are applicable to bundles of potentially hundreds, thousands, or more diamond types. In a particular non-limiting example, a diamond bundle contains 25 diamond types.

The diamond bundles described herein are selected from the “universe of diamonds” composed of diamond types of every possible physical characteristic and variation for which at least one market value has been assigned.

As discussed herein, diamonds (rough and cut) are classified and graded based on their physical characteristics and in particular examples, on the laboratory that provides the grading report.

Rough diamonds are typically classified, graded, valued, and traded based on differences in shape (e.g. octahedron, sawable, cleavage, makable, flat, crystal, and maacle), size range, color, clarity, and cut estimate.

Cut diamonds are typically classified, graded, valued, and traded based on several physical characteristics of individual stones, including, but not limited to, size ranges, shape, cut, clarity, color, polish, symmetry, fluorescence, finish, and light performance. Cut diamond value is often also based on the source and reputation of the gemological laboratory providing the grading report for an individual stone.

Diamond size is typically a measure of diamond weight, which is measured in “carats.” One carat is equivalent to 200 milligrams. Diamond price lists generally group the size rages of diamonds from stones as small as 0.00-0.30 of a carat to stones as large as 5.99 carats. In particular examples, diamond price tables group diamond size ranges from 0-0.30; 0.30-0.39; 0.40-0.49; 0.50-0.59; 0.60-0.69; 0.70-0.79; 0.80-0.89; 0.90-0.99; 1.0-1.19; 1.20-1.49; 1.50-1.69; 1.70-1.99; 2-2.99; 3-3.99; 4-4.99; and 5-5.99 carats. One of skill will appreciate that multiple variations of size ranges are possible in market data.

Typical diamond shapes include, but are not limited to, Round, Princess; Radiant; Marquise, Asscher; Pear, Oval, Emerald, Cushion; Trilliant; and Heart.

Diamond “cut” refers to physical proportions and angles of diamonds including polish, symmetry, and finish. Different diamond grading laboratories have developed varying grades for diamond cut. These laboratories include, but are not limited to the American Gem Society (AGS); the Gemological Institute of America (GIA), and Rapaport laboratories (RAP). In a particular example, the cut grading system of the GIA describes a diamond cut as poor, fair, good, very good, or excellent.

Diamond color may range from perfectly colorless to having tints of yellow, brown, gray, or any combination thereof. Color is graded alphabetically from D-Z, according to tint. A range of colors from D to N is most commonly found on commercial diamond price lists.

Diamond clarity describes the internal flaws or “inclusions” that can affect the appearance of a diamond. Clarity is graded on scale of decreasing value from Flawless (FL), Internally Flawless (IF), Very Very Slightly Included 1(VVS1), Very Very Slightly Included 2 (VVS2), Very Slightly Included 1 (VS1), Very Slightly Included 2 (VS2), Slightly Included 1 (SI1), Slightly Included 2 (SI2), and Included 1 (I1).

Fluorescence is a measure of the degree to which a given diamond will glow when exposed to ultraviolet light. In particular examples, fluorescence is graded in a range from faint, medium, strong, and very strong.

Diamond value (and a determining factor of diamond types in a bundle) is also influence by the grading laboratory and its reputation. Accordingly, in particular examples, a stone with a grading report from one laboratory may be more highly valued (e.g. have a greater market price) than a stone having the identical grading report from a laboratory of lesser reputation.

In particular embodiments the method executed by the processor (10, FIG. 1) contains pre-set specified diamonds for inclusion in a diamond bundle. In an exemplary pre-set bundle, every bundle used in the method would contain 12 diamond types, each being one carat, “rounds,” having four color grades from D to G, with each color grade having three grades of clarity: IF, VVS1, and VVS2. In another exemplary pre-set bundle, every bundle in the method would contain 25 diamond types, each diamond being a range of 1.01-1.19 carats, having a “round” shape, and five color grades from D to H, with each color grade having the five descending clarity grades, from IF to VS2. The cut and polish grades of the diamond types in either exemplary bundle would very good or excellent, and the grading lab in such an exemplary bundle would be the GIA.

In other embodiments, a user is prompted by the system to select all of the characteristics of the diamond types to be bundled, for example, a given bundle may be based on user-selected characteristics of diamond number, weight, cut, shape, color, clarity, and symmetry. In such examples, the user also determines which characteristics are constant among the diamond types in the bundle and for which characteristics a range is present. For example, a user might define a diamond bundle based on 20 diamond types, wherein the diamond shape and clarity are constant, but the weights vary. An exemplary bundle having these specifications might contain 20 “Marquis” diamonds, which have a VVS1 clarity, possess a range of five color types from D to H, and a range of four weights of 0.5, 1.0, 1.5, and 2.0 carats.

In still other embodiments, some characteristics of the diamond bundle and the diamond types in the bundle are pre selected (pre-set), and are part of every process of bundle formation and point assignment, while other characteristics are user-selected. In such embodiments, the system will prompt the user to select those characteristics which are not pre-set. Any of the described bundle characteristics can be preset. For example, an exemplary bundle might be pre-set to contain 25 diamonds having a constant color grade of “E,” but then prompt a user to select whether the bundle is to have variations in weight, cut, and clarity.

In another embodiment, the constituents of the diamond bundle are dictated by the specification of a contract that will utilize the diamond points as the contract units of exchange. In such examples, the bundle characteristics can be pre-set, or entered into the system by the user according to the contract specification.

Once a diamond bundle is defined, its selected characteristics are stored in the memory (20, FIG. 1), which can be local memory storage or transmitted to an external database. In particular examples, the stored diamond bundles are organized so that a user can search and access information for diamond bundles possessing particular characteristics. In further examples, the stored diamond bundles can be accessed and used as a “pre-selected” diamond bundle in the methods described herein.

### Market Data

The systems and methods described herein utilize available market data for rough and cut diamonds of all available diamond types within the universe of diamonds. As described above, the universe of diamonds comprises all diamonds having all available combinations of particular characteristics, for which market data, (e.g. price of a stone or price per carat) is available. One of skill in the art will appreciate therefore, that the current systems and methods can be applied to any diamond type for which market data are available.

Myriad sources of diamond market data are available, and the described methods can use all available market data, or a subset of the available market data. As indicated herein, the market data utilized in the described systems and methods includes publicly available market data. In some examples publicly available market data include free price lists, such as those found on retail diamond outlets. In other examples, publicly available market data include those price lists or diamond valuations available for a fee.

In particular examples, available market data include wholesale prices for diamonds of each particular type, such as those prices by which diamond retailers purchase diamonds from diamond wholesalers. Examples of prices include diamond asking price, auction bid price, and transaction prices, such as cash transaction price. Sources of diamond wholesale prices include, but are not limited to the RAPNET® diamond price list, the Polygon diamond price lists, and others. In other examples, available market data include retail prices for diamonds of each particular type. Sources of diamond retail prices include, but are not limited to diamond retailers such as Blue Nile and Costco. In particular examples, the wholesale or retail prices include asking prices for a diamond having particular characteristics (such as the best asking price). In other examples the wholesale or retail prices include transaction prices for a diamond having particular characteristics. In some examples, the market data includes past, current, or projected valuations for diamonds of a particular type. In other examples, the market data includes the terms and conditions of sale for particular diamond type prices. In some examples, the prices utilized by the described methods can be the “raw” price for individual stones of varying sizes. In other examples, the obtained prices are converted to a “price per cart” value.

The methods described herein include accessing the available market data for the universe of diamonds (110), and selecting and obtaining available market data for a subset, or bundle, of diamond types (120). Selecting and obtaining available market data (120) includes accessing and obtaining at least one market price for each diamond type in the bundle. In particular examples, the market data is accessed from multiple on-line sources simultaneously, or nearly simultaneously, such as multiple retail price lists or multiple databases of diamond prices, and are accessed by a computer through an internet connection. In other examples, the market data is accessed from a single database. In particular examples, the single database is available from a single on-line source accessed over the internet. In other embodiments, the single database is available from an off-line database. In particular examples, the off-line database is accessed over an internal computer network. In other examples, the off-line database is stored in the memory of the described system. One of skill in the art will appreciate that a single database of market data may not contain available diamond market values for every diamond selected by a user to be in a diamond bundle. Thus, in still other examples, the market data is accessed from multiple sources including combinations of one or more off-line databases, one or more internal-network accessible databases and one or more on-line databases or price lists.

In still other examples, it is beneficial for the system to access certain market data, but not others. For example, the system can be programmed to obtain only market data based on actual diamond sales. In other examples the system can be programmed to obtain only market date based on diamond asking prices. In still other examples, the system obtains market data from all available sources, but will then reject and discard the obtained data if it does not meet specified criteria.

### Analyzing Market Prices for Diamond Bundles

After market data is accessed and obtained, the described system analyzes the market data to determine and assign a single market price for each of the selected diamond types in the bundle. As used herein, “analyzing market prices” indicates the process by which a single market value, or single price, is determined for each of the selected diamond type, based on the market data obtained for each of the selected diamond types. One particular example of the sub-process of “analyzing market prices” is shown in FIG. 3.

With reference to FIG. 3, after market data is accessed, selected, and obtained, the described system will determine whether a single market price has been obtained (210). In particular examples, the diamond bundle includes a diamond type for which only a single market price is obtained. If only a single market price is obtained, the system assigns the obtained market price to the selected diamond type (220).

In most examples the market data that is accessed and obtained for each diamond type in a bundle will contain multiple market prices. Moreover, in some examples the market prices can vary widely. Therefore, the system next performs a statistical analysis to determine the existence of outliers (230) and remove any outliers from the set of obtained market prices (240). Any type of statistical analysis known in the art can be used to determine the existence of outliers. In a particular example, the obtained market prices are analyzed to determine the standard deviation between each obtained market price for a diamond type. In a particular example, only the central 70% of prices clustered around the average are retained, while the remaining 15% on either side of the average cluster are removed.

In another example, the statistical analysis is used to determine the market price to be assigned. For example, a left-tail analysis can be used to determine the market price. In such an analysis, the mean and standard deviation of a group of market prices are determined. Either side of the 70% confidence interval is a 15% “tail.” In a left-tail analysis, the lower or “left” 15% confidence interval is further analyzed, and the median value of the left tail is used as the market price.

Once the statistical analysis is performed, which in the particular non-limiting example shown, results in removal of outliers from the set of market prices (240), the system determines the average (mean, mode, or median) market price (250) and assigns an average market price for each diamond type (260).

One of skill will appreciate that many ways of assigning a single “market price” from a group of market prices are encompassed by the disclosed methods.

### Arranging Diamond Bundles

In some embodiments, once a single price is determined for each diamond type in a bundle, the system virtually organizes or “arranges” the diamond types in the bundle into a virtual table. Arranging the bundle provides a virtual organizational structure to the bundle which can be used in some embodiments in determining diamond points and in selecting diamonds for points-based contracts. In particular examples, the diamonds are arranged according to their physical characteristics. For example, the diamonds in a bundle can be arranged in a virtual table in a manner similar to that generally used for diamond price lists. An exemplary table (without values) is shown in Table 1:

TABLE 1
Diamond Classification Table
A bundle of one carat (1.01-1.19) “round” diamonds is shown:

| | IF | VVS1 | VVS2 | VS1 | VS2 |
|---|---|---|---|---|---|
| D | — | — | — | — | — |
| E | — | — | — | — | — |
| F | — | — | — | — | — |
| G | — | — | — | — | — |
| H | — | — | — | — | — |

Table 1 presents a diamond classification table for an exemplary diamond bundle. The exemplary diamond bundle contains 25 diamond types, wherein each diamond is a one carat, round stone having a range of five color grades from D-H, and having a range of clarity grades from IF to VS2.

One of skill in the art will appreciate that although Table 1 shows a common method of arranging a grouping of diamonds, myriad virtual arrangement methods are possible. In particular examples, diamonds can be virtually arranged according to a particular physical characteristic, thus producing a list in ascending or descending order of color, clarity, or size range and the like. In other particular examples, diamonds in a bundle can be virtually arranged based not on physical characteristics, but in ascending or descending order of assigned market value, such as price of individual diamond types or price per carat.

### Determining a Reference Diamond

The described systems and methods determine the relative value of diamonds in a given bundle in relation to a “reference diamond.” The reference diamond can be any diamond type selected from the universe of diamonds, for which a market value can be obtained.

In particular embodiments, the reference diamond is determined from among the diamond types selected for the diamond bundle. In such examples, the market price of the reference diamond has already been determined, as described above.

In some examples, determination of a reference diamond is based upon one or more of the characteristics of the diamonds in the bundle. In some examples, the reference diamond is the “middle” diamond in a virtually-arranged bundle, such as a diamond type of median quality. In one such exemplary grouping, such as the diamond bundle shown in Table 1, the reference diamond would be a 1 carat, round stone, having a color grade of F and a clarity grade of VVS2. In other examples the reference diamond is the diamond having a market price closest to the mean market price of all the diamond types in the bundle. In still other examples, the reference diamond is the diamond which has the median, mean, or mode of market price of the market values for the diamonds in the bundle.

In some embodiments, the reference diamond is not a diamond type present in the diamond bundle. In such examples, the processor accesses market data for the universe of diamonds in determining the reference diamond, and its market price. In particular examples, the reference diamond is found in a subset of diamonds separate from that selected in the described method. In other examples the reference diamond is the average price of a diamond having a particular set of characteristics. For example, an illustrative reference diamond can be a 0.50 carat round diamond of G color and VS1 clarity, regardless of whether that diamond type is found among the types selected for the diamond bundle. Other non-limiting examples of a reference diamond include the most frequently traded diamond type on a given day, mean market price of all of the diamonds for sale on a given day, median quality of all of the diamonds for sale on a given day and the like. Accordingly, one of skill will appreciate that in particular examples, the “reference diamond” is not a particular diamond type, but rather is a statistical point of reference, which can bridge multiple diamond types having multiple diamond characteristics.

In particular examples, determining the reference diamond is a sequential part of the process of determining diamond points (e.g. as illustrated in FIG. 2). In other examples, the reference diamond is not a sequential part of the process, and may be pre-determined for a given period of time such as a day, month, quarter and the like.

### Determining Diamond Points

Diamond points are bundle-specific indicators of the relative value of each diamond type in the given bundle, in relation to the reference diamond. Multiple methods of determining the proportional value of one number relative to another are possible, and are encompassed by the described methods.

In particular embodiments, the processor determines diamond points (the proportional value of each diamond type in the bundle, relative to a reference diamond) using the using the equation ((X−Y)/Y)+1, wherein X is the assigned market price of a specific diamond type, and wherein Y the assigned market price of the reference diamond.

In particular examples, relative diamond points are determined for all of the diamond types in a bundle. In other examples, relative diamond points are determined for a sub-set or sub-bundle of the bundled diamond types.

Once diamond points are calculated for each diamond type in the bundle, the calculated points are stored in the computer memory for later use and displayed on a display. In some embodiments, the calculated points are transmitted to another computer. In particular examples, point values for a diamond bundle are communicated to another computer over an internal network (intranet). In other examples, point values are communicated to another computer over am external network (internet). In particular embodiments, the composition of the diamond bundle (e.g. the identities of the component diamond types) and the points assigned to each diamond type in the bundle are stored in a database of diamond bundles and assigned points.

### Updating Diamond Points

Diamond points are used as the unit of exchange in various diamond-based contracts, as discussed in further detail below. It will be appreciated that because diamond points are based on market data, which change over time, in particular examples it will be necessary to periodically recalculate points. The frequency with which the point values in a bundle are updated can depend on a variety of considerations including, but not limited to the frequency with which market data for specific diamonds in a bundle is updated and the specifications of points-based contracts.

In particular examples, the described system is programmed to update the determined diamond points in a bundle continuously, or at least once a day, or at least once a week, or at least once a month. In other examples, the described system is programmed to update the determined diamond points in a bundle each time a bundle is accessed for use in a points-based contract. In still other examples, diamond points in a bundle are continuously updated.

An exemplary process for updating diamond points is shown in FIG. 4. Unlike the determination of diamond points outlined in FIG. 2, the process of updating diamond points begins with a pre-selected, pre-arranged diamond bundle. However, the basic processes of obtaining market data and determining diamond points are the same as described above.

With reference to FIG. 4, to update diamond points, the system accesses the diamond bundle and associated diamond type characteristics from the system memory (410). In particular embodiments, system memory includes an external memory that stores a database of diamond bundles and assigned diamond points. The system next obtains market data for each of the diamonds in the bundle (420). The market data is then analyzed as described above to assigned a single market price to each diamond type (430; see FIG. 3). As previously discussed, in some examples, diamonds in a bundle are virtually arranged as a function of the assigned market prices. Therefore, the system determines if the bundle being updated was arranged according to average market price of the diamond types in the bundle (440). In examples wherein the bundle was so arranged, updating the market prices of the bundled diamonds may require that the diamond types be rearranged according to the updated market values (450). This may be particularly true in those examples where the bundled diamond types includes rarer diamond types or diamond types more sensitive to supply availability.

As described above, in some examples the reference diamond is determined as a function of market data for the universe of diamonds. In such examples, the identity and value of the reference diamond is also updated according to the methods discussed above (460). In other examples, the reference diamond does not need to be re-determined. However, even in such examples, market data for the reference diamond is accessed and obtained. Regardless of whether updating market data requires the diamond bundle to be rearranged or requires the reference diamond to be re-determined, the process then proceeds with recalculating diamond points by the method previously used (470). As described above, the recalculated (updated) diamond points are stored (480) in the system memory (20, FIG. 1), displayed (490) on the system display (30, FIG. 1), and alternatively communicated to an external computer over an intranet or internet network (e.g. such as an external computer storing a database of diamond bundles and assigned points).

### IV. Diamond Points-Based Contracts

The systems and methods described herein determine the relative value of selected diamond types within a subset or “bundle” of diamonds. The determined relative values or “points” for the diamond types in the bundle are used by the computer in the described system, or computers comparable thereto, as the basis for transaction units in points-based diamond contracts.

Once determined for a diamond bundle, points are interchangeable. Points-based contracts allow buyers and sellers to set contracts having a desired value for multiple sub-sets of diamond types from the same diamond bundle, but without needing to specify a particular diamond type. For example, a contract governing the purchase of “25 points” from a diamond bundle can be used for any possible combination of diamond types from the bundle, as long as 25 points are exchanged, subject only to the restrictions on diamond types that might be specified by the contract.

One of skill in the art will appreciate that any type of contract can be based on diamond points including, but not limited to simple buying and selling of diamonds, futures contracts, contracts used in an a diamond exchange traded fund, futures options, as the basis for electronic currency backed by a diamond inventory, and as the basis for a price index to create a cash-settled exchange traded fund. Such contracts can be developed on an individual basis or as part of a public exchange, such as the Chicago Board of Trade and the like. In other embodiments, diamond points-based trading can be the basis for a point-based financial market.

Points-based diamond contracts are governed by multiple specifications including, but not limited to number of points, number of diamonds required for delivery, particular subsets of diamond type, overall price of the exchange, delivery time, mode, and market, and other terms and conditions of sale.

In particular embodiments, points-based contracts are based on pre-selected diamond bundles, for which points have already been determined and stored in memory, such as by the exemplary process shown in FIG. 2. In other embodiments, the contract specifies a subset of diamonds types which have not previously been bundled. In such embodiments, the diamond bundle is based on the contract.

In particular embodiments, a user inputs the contract-specified diamond types into a computer with access to a database of pre-determined diamond bundles. In such embodiments, the computer executes a program to search the database (or databases) of determined diamond bundle is present in the database. Such a pre-determined bundle can then be used as the basis for the points in the contract. In particular examples, once a diamond bundle is accessed, the point values in the bundle are automatically updated, as illustrated in FIG. 4. In other examples, the user will be given the option of whether to update the points in the accessed bundle.

In still other examples, the user-specified diamond types do not match a pre-determined diamond bundle. In some examples, the processor will automatically execute the program described above, and outlined in FIG. 2, to assemble a diamond bundle, and determine the points of each of the diamond types in the bundle.

A particular advantage of points-based diamond contracts is the flexibility with which points can be used and adjusted to fulfill a contract specification. For example, if diamond points are calculated for a bundle of one carat diamond types, but a contract specifies a transaction of points from two carat diamonds that are otherwise identical to the bundled one carat stones, the point system allows the point values of the one carat stones to be doubled to match the specified two carat size.

Additionally, as discussed above, points-based diamond contracts enable delivery of multiple combinations of diamond types to fulfill a contract specification (as long each combination adds up to about the same number of points). Points-based contracts can be developed with greater or lesser restrictions on the source of points from within a diamond bundle. In particular examples, any combination of diamond types can be used to fulfill the contract. In other examples, the contract specifies how different diamond types from the bundle can be combined.

In particular examples, the diamond types are selected randomly through use of a random number generator. In some examples the random-number generator is implemented by a computer processor (45, FIG. 1). Random selection of diamond types can be accomplished by designating a number from 1 to n for each diamond type in a bundle, with n being the total number of diamond types in the bundle. A random number from 1-n is generated, and the corresponding diamond type is selected. The process is repeated until the number approximates the total number of points specified in the diamond bundles for a match to the specified diamond types.

In other examples, the diamond types in a contract are selected by a process described herein as “sub-bundling.” In such examples, a contract will specify the number of points that may be selected from given types of diamonds within a sub-bundle. In still other examples, the contract can specify the parameters of minimum or maximum numbers of points that can come from any given sub-bundle. In particular examples, sub-bundles are produced as a function of the point value of the diamonds in the bundle. In other examples, sub-bundles are produced according to particular diamond characteristics. Two examples of sub-bundles are illustrated by FIG. 5:

FIG. 5a illustrates sub-bundling of a standard diamond organization table according to exemplary criteria. The four sub-bundles illustrated in FIG. 5a are defined as (1) 1 carat, round stones of D-E color and IF-VVS1 clarity; (2) 1 carat, round stones of D-E color and VVS2-VS2 clarity; (3) 1 carat, round stones of F-H color and IF-VVS1 clarity; and (4) 1 carat, round stones of F-H color and VVS2-VS2 clarity.

FIG. 5b illustrates an alternative example of how the diamond types in FIG. 5a can be bundled according to clarity.

A sub-bundle can be divided up by any criteria specified by the parties in a contract. In particular examples, at least two, at least three, at least four, at least five, at least six or more sub-districts are defined. Sub-bundling criteria in a contract, such as the minimum and maximum number of diamond types, or diamond points in a sub-bundle ensures reasonable portfolio diversification in the contract.

The points-based contracts described herein specify a number of diamond points, assembled from a bundle of diamond types, to be exchanged for a specified amount of money. One of skill will appreciate however, that in particular examples, the selected diamond types from a bundle will not add up to the exact number of diamond points specified in the contract. This is similarly true in examples, such as those wherein diamond types are randomly selected or specified numbers of points are selected from sub-bundles. In particular examples, the points-based contracts comprise terms which compensate for a surplus or deficit in points by an amount of money equal to the number of points over or under the amount specified by the contract. In such examples, the required compensating money is determined by calculating the monetary value of a diamond point in a bundle (e.g. based upon the value of the reference diamond), and multiplying that value by the surplus or deficit.

Similarly, in particular examples, the contract can specify a set amount of money to be exchanged for a certain number of points at a later date. Such contracts can specify that any differences between monetary point value at the time of diamond delivery and the original cash exchanged can be compensated with additional money. In particular examples, the cash value of the exchanged diamonds is determined with reference to the average market price of the individual stones, such as the price per carat of each of the diamonds exchanged.

The following examples are provided to illustrate certain particular features and/or embodiments. These examples should not be construed to limit the disclosure to the particular features or embodiments described.

### EXAMPLES

### Example 1

### Determination of Diamond Points in a Bundle

This example demonstrates the determination of diamond points in a selected bundle.

Using a computer, a user defined a diamond bundle of 25 diamond types according to the characteristics of: (1) weight=1 carat; (2) shape=round; (3) color grades D, E, F, G, and H; and (4) clarity grades IF, VVS1, VVS2, VS1, and VS2.

The RAPNET® diamond price database was accessed to obtain the market value (price per carat) of each of the specified diamond types, and the diamond bundle was arranged as shown in Table 2:

TABLE 2
Diamond Bundle

| | IF | VVS1 | VVS2 | VS1 | VS2 |
|---|---|---|---|---|---|
| D | 22882 | 16961 | 14716 | 12195 | 10254 |
| E | 15702 | 14225 | 11701 | 10259 | 8817 |
| F | 13212 | 11611 | 9880 | 9490 | 7934 |
| G | 10862 | 10109 | 9391 | 7897 | 7242 |
| H | 9033 | 8743 | 7777 | 7073 | 6524 |

The reference diamond was determined by identifying the “central” diamond in the selected bundle, in this instance, a 1 carat round diamond of color grade F and clarity grade VVS2 (in bold). Diamond points (proportional diamond values) were determined according to the equation (X−Y/Y)+1, wherein X was a specific diamond type, and wherein Y was the reference diamond. The results of this determination are shown in Table 3 (reference diamond point value in bold):

TABLE 3
Proportional Diamond Values (Diamond Points)

| | IF | VVS1 | VVS2 | VS1 | VS2 |
|---|---|---|---|---|---|
| D | 2.32 | 1.72 | 1.49 | 1.23 | 1.04 |
| E | 1.59 | 1.44 | 1.18 | 1.04 | 0.89 |
| F | 1.34 | 1.18 | 1.00 | 0.96 | 0.80 |
| G | 1.10 | 1.02 | 0.95 | 0.80 | 0.73 |
| H | 0.91 | 0.88 | 0.79 | 0.72 | 0.66 |

### Example 2

### A Points-Based Diamond Contract

This example shows the use of calculated diamond points to develop a points-based diamond contract.

A diamond contract was developed using the points determined in Example 1. The contract specified that a group of diamonds having a total of ten points (at the time of delivery) would be exchanged for $100,000 at an earlier date. Any imbalances between the money paid and the monetary value of the ten points (at the time of diamond delivery) was to be made up in cash. The contract also required that the diamonds in the contract be taken from a variety of color and clarity grades, but did not specify the method by which the variety was to be determined Table 4 shows the actual carat weights of the diamonds selected for the ten-point contract:

TABLE 4
Diamonds in Ten-Point Contract (carat weights are shown)

| | IF | VVS1 | VVS2 | VS1 | VS2 |
|---|---|---|---|---|---|
| D | 1.01 | | | 1.01 | |
| E | | 1.12 | | | |
| F | | | 1.05 | | 1.23 |
| G | 1.10 | | | | |
| H | | | | 1.01 | 1.26 |

In Example 1, points were determined for diamonds of 1 carat weight. The determined points provided a useful benchmark for the developed diamond contract, for which diamonds of varying weights were used. The actual number of points of the diamonds shown in Table 4 was determined by multiplying the weight of each stone shown in the table by the point values shown in Table 3. The results of this calculation are shown in Table 5. Total points of the selected diamonds are also shown.

TABLE 5
Point Values of Diamonds in the Contract

| | | | | | | Total |
|---|---|---|---|---|---|---|
| | IF | VVS1 | VVS2 | VS1 | VS2 | Points |
| D | 2.34 | — | — | 1.24 | — | 3.58 |
| E | — | 1.61 | — | — | — | 1.61 |
| F | — | — | 1.05 | — | 0.99 | 2.04 |
| G | 1.21 | — | — | — | — | 1.21 |
| H | — | — | — | 0.73 | 0.83 | 1.56 |
| | | | | | | 10.00 |

Table 5 demonstrates how the points determined for the selected diamonds added up to 10, and thus fulfilled the specification of a ten-point contract. As indicated above, the contract specified that the ten-point bundle was to be traded for $100,000, with any differences between the money and the value of the delivered ten points of diamonds to be made up in cash. The dollar value of each diamond delivered was therefore determined by multiplying the 1-carat dollar values shown in Table 2 by the actual diamond weights shown in Table 3. The results of this calculation are shown in Table 6, along with the total dollar value of the diamonds in the bundle.

TABLE 6
US Dollar Value of Diamonds in Bundle

| | | | | | | Total |
|---|---|---|---|---|---|---|
| | | | | | | Diamond |
| | IF | VVS1 | VVS2 | VS1 | VS2 | Value ($) |
| D | 23,111 | — | — | 12,317 | — | 35,428 |
| E | — | 15,932 | — | — | — | 15,932 |
| F | — | — | 10,374 | — | 9,759 | 20,133 |
| G | 11,948 | — | — | — | — | 11,948 |
| H | — | — | — | 7,144 | 8,220 | 15,364 |
| | | | | | | 98,805 |

Table 6 shows that the ten-point diamond contract has a dollar value of $98,805, not $100,000. The contract specified that any imbalances in dollar value would be made up in compensating money. Therefore, the party delivering the diamonds also provided an extra $1,195 at the time the ten-point diamond bundle was exchanged.

### Example 3

### Balancing of Diamond-Type Selection by Bundle Sub-Districting

This example shows use of bundle sub-districting in a points-based contract.

Example 1 describes a diamond bundle and determination of points in the bundle. Example 2 describes a contract for ten diamond points, but does not specify how the diamonds in that contract are to be selected to add up to ten points. An additional contract can be developed, similar to the one described in Example 2, but specifying that bundle sub-sub-districting be used to ensure variety to the delivered diamonds. Such an exemplary contract can specify delivery of ten points worth of diamonds from the bundle shown in Example 1, for $100,000 at the time the contract is signed. The contract further specifies that to ensure a variety of diamonds, the bundle illustrated in Table 3 is to be divided into the following three sub-districts: (1) color D-E; clarity IF-VVS1; (2) color F-H; clarity IF-VVS1; and (3) color D-H; clarity VVS2-VS2. The contract further specifies that one diamond be taken from the first sub-district, two from the second, and any remaining points be made up of diamonds from the third. The remainder of the contract operates as described in Example 2.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A computer-implemented method for bundling diamonds into valued groupings, comprising:
accessing market data for available diamond types in the universe of diamonds, wherein the market data includes at least one market price for each diamond type;
selecting and obtaining, from the market data, market prices for diamond types in a diamond bundle;
analyzing the obtained market prices for each diamond type in the bundle;
assigning a price to each diamond type in the bundle based on the analyzed market prices;
determining a reference diamond type from the universe of diamonds;
assigning a price for the reference diamond;
assigning a number of points to each diamond type in the bundle based on their price, relative to the reference diamond price;
storing in a memory, the diamond types in the diamond bundle and the point values for each diamond type; and
displaying on a display the point value for each diamond type in the diamond bundle.

2. The method of claim 1, wherein all characteristics of the diamond types in the diamond bundle are pre-selected.

3. The method of claim 1, wherein a user selects all characteristics of the diamond types in the diamond bundle.

4. The method of claim 1, wherein some characteristics of the diamond bundle are pre-selected, and other characteristics of the diamond bundle are user-selected.

5. The method of claim 1, wherein the characteristics of the diamond types in the diamond bundle comprise at least one of size ranges, shape, cut, clarity, color, polish, symmetry, fluorescence, finish, and light performance.

6. The method of claim 1, wherein the market data is accessed and obtained from a single source of market data.

7. The method of claim 1, wherein the market data is accessed and obtained from multiple sources of market data.

8. The method of claim 1, wherein the market data is simultaneously accessed and obtained from multiple sources of market data.

9. The method of claim 1, wherein analyzing the market prices comprises a statistical analysis of the obtained market prices.

10. The method of claim 1, wherein assigning a price to each diamond type comprises determining the mode, mean, or median of the market prices for each diamond type.

11. The method of claim 1, wherein the reference diamond is among the diamond types in the diamond bundle.

12. The method of claim 1, wherein the reference diamond is not among the diamond types in the diamond bundle.

13. The method of claim 1, wherein determining a price for the reference diamond comprises:
accessing market data for the reference diamond, wherein the market data includes at least one market price;
analyzing the obtained market prices;
assigning a price to the reference diamond based on the analyzed market prices.

14. The method of claim 1, wherein storing in the memory comprises communicating the diamond types in the diamond bundle and the point values for each diamond type to an external computer.

15. The method of claim 1, further comprising
updating the assigned point values for each diamond in the diamond bundle to account for changes in market prices of the diamonds in the bundle;
storing in the memory the updated point values; and
displaying on the display the updated point values.

16. The method of claim 15, wherein the point values are updated each time the diamond bundle and corresponding point values are accessed from the memory.

17. The method of claim 1, further comprising
accessing from the memory, the diamond bundle and corresponding point values;
updating the assigned point values to account for changes in market prices; and
selecting diamond types from the bundle for use in a diamond-points-based contract.

18. The method of claim 17, wherein the contract is selected from the group comprising a sales contract, futures contract, contracts used in a diamond exchange traded fund, a futures options contract, a contract that is the basis for electronic currency backed by a diamond inventory, and a contract that is the basis for a price index to create a cash-settled exchange traded fund.

19. A system for bundling diamonds into valued groupings, comprising:
a processor that executes a program for performing a method;
means for sending and receiving data;
memory for storing the results of the method; and
a display for displaying the results of a method, wherein the system:
accesses market data for available diamond types in the universe of diamonds, wherein the market data includes at least one market price for each diamond type;
selects and obtains, from the market data, market prices for diamond types in a diamond bundle;
analyzes the obtained market prices for each diamond type in the bundle;
assigns a price to each diamond type in the bundle based on the analyzed market prices;
determines a reference diamond type from the universe of diamonds;
assigns a price for the reference diamond;
assigns a number of points to each diamond type in the bundle based on their assigned price, relative to that of the reference diamond;
stores in a memory, the diamond types in the diamond bundle and the point values for each diamond type; and
displays on a display the point value for each diamond type in the diamond bundle.

20. The system of claim 19, wherein the point values for each diamond type are updated to account for changes in market prices each time a user accesses the diamond bundle and corresponding point values from the memory.
